(19) United States
(12) Patent Application Publication
(10) Pub. No.: US 2006/0251080 A1
(43) Pub. Date: Nov. 9, 2006

(54) Method for increasing bandwidth utilization in centrally scheduled networks when using connection oriented protocols

(76) Inventor: Steven Krapp, Naperville, IL (US)

Correspondence Address: ARRIS INTERNATIONAL, INC, 3871 LAKEFIELD DRIVE, SUWANEE, GA, 30024, US

(21) Appl. No.: 11/391,622

(22) Filed: Mar. 28, 2006

Related U.S. Application Data
(60) Provisional application No. 60/665,791, filed on Mar. 28, 2005.

(51) Int. Cl. H04L 12/56

(52) U.S. Cl. 370/394

(57) ABSTRACT

The receipt at a network access device of an acknowledgement packet from a destination host is anticipated upon the receipt at the network access device of a data packet destined to the host from a centralized scheduler. The access device generates a bandwidth request for sending the acknowledgement packet and sends the bandwidth request to the scheduler before the anticipated acknowledgement packet is received from the host. If aggregation is enabled, the bandwidth request may request enough bandwidth to forward a predetermined number of acknowledgement packets from the host to the scheduler. Aggregation and anticipation may be combined.

### CROSS REFERENCE TO RELATED APPLICATION

This application claims priority under 35 U.S.C. 119(e) to U.S. provisional patent application No. 60/665,791 entitled “Method for increasing bandwidth utilization in centrally scheduled networks when using connection oriented protocols,” which was filed Mar. 28, 2005, and is incorporated herein by reference in its entirety.

### FIELD OF THE INVENTION

This invention relates, generally, to communication networks and devices and, more particularly, to increasing bandwidth using connection oriented protocols.

### BACKGROUND

Data-Over-Cable Service Interface Specifications (“DOCSIS”) has been established by cable television network operators to facilitate transporting data traffic, primarily internet traffic, over existing community antenna television (“CATV”) networks. In addition to transporting data traffic as well as television content signals over a CATV network, multiple services operators (“MSO”) also use their CATV network infrastructure for carrying voice, video on demand (“VoD”) and video conferencing traffic signals, among other types.

Various protocols may be used for transporting data back and forth between hosts (computer, set top box, etc.) over a network. Some of the protocols, such as UDP, are known in the art as best effort, which mean packets are sent towards a destination. If some packets do not arrive, the stream of packets continues anyway.

Other protocols that are sometimes referred to as “connection oriented protocols” require acknowledgement from the receiving host that packet(s) have arrived before a sending host will send more packets. An example of a connection oriented protocol is TCP. It can be shown that the packet rate of these protocols is proportional to the round trip time, time Trtt, between a sending host sending a packet and receiving an acknowledgement packet that the sent packet was received by the destination, or receiving, host.
Packet Rate=1/Trtt Eq. 1
It will be appreciated that Trtt is the sum of network latencies Tn and the processing time on Host B, Tp.
Trtt=Tn+Tp

Some connection oriented protocols use a “window” during which up to N packets can be sent prior to receiving any acknowledgement. For these protocols, it can be shown that the packet rate is proportional to N/Trtt. Thus,
Packet Rate˜N/Trtt. Eq. 2
TCP is an example of a windowing connection oriented protocol.

There exists a class of networking systems that utilize a shared medium for many hosts. In this class of networks there exists a subclass that uses a centralized scheduler to determine media access. In these systems, hosts are connected to the network via an access terminal. When a host wishes to send data, it sends it to its corresponding access terminal and the access terminal then sends a request to the centralized scheduler. The scheduler then grants access to the access terminal at some point in the future. At the designated time the access terminal sends the data from the host.

This class of networks may be referred to as a centralized scheduling networks (“CSN”). In a CSN the period starting when the access terminal sends a request to the scheduler and ending at the time when the access terminal can send the data acknowledgement packet is referred to as the request-grant cycle or RGC period (“T_{RGC}”). A Cable Modem Termination System (“CMTS”) along with one or more cable modems is an example of CSN. In such a system the CMTS is the centralized scheduler and the cable modem is the access terminal.

Turning now to the figures, FIG. 1 shows a message sequence diagram 10 where first host A 12 and second host B 14 are connected to each other through a series of network devices. First host 12 is connected to a router 16 via network 17 and second host 14 is connected to a CSN 18.

Diagram 10 shows that the round trip time Trtt 20 is essentially equal the sum of Tp 22, Trgc 24, and Tn, where Tn is any additional latency due to the network devices such as the router. Thus,
Trtt=Tp+Trgc+Tn Eq. 3

In this network scenario shown in diagram 10, the bandwidth that can be used by a connection oriented protocol from first host 12 to second host 14 is equal to the packet rate multiplied by the average packet size or:
BW_{ab}=Average Packet Size*N*(1/(Tp+Trgc+Tn) Eq. 4
N is the number of packets in the window. In FIG. 1, N=1 to reduce visual clutter on the sequence diagram 10.

As long as BWab is greater than the total bandwidth between scheduler 26 and access terminal 28, system 30 is able to achieve 100% utilization of the link 27, such as, for example, a hybrid fiber coaxial network (“HFC”), between the scheduler and the access terminal. However, as the bandwidth between scheduler 26 and access terminal 28 is increased, a point is eventually reached where this bandwidth is greater than BWab, at which point the limiting factor on packet rate becomes BWab.

This is a problem in CSN networks. MSOs desire to increase the total amount of bandwidth available to their subscribers such as first host 12. However despite investing in the technology to provide this increased bandwidth, first host 12 is often not able to utilize all of this bandwidth when using connection orientated protocols such as TCP, the protocol of which most Internet traffic comprises.

In order to increase effective BWab in CSNs there are several options. First the average packet size can be increased. However, there are limits set on the packet size by the networking technologies in use today. Therefore, this value is likely at its maximum value in most current networking systems.

Next the value N can be increased. This is very effective. However to increase this value N requires modifications to first host 12. Furthermore, it is not possible that every host will be under the control of the same MSO that operates CSN 18 providing service to first host 12. Thus, N is essentially fixed. In addition, increasing N increases memory requirements on second host 14. This is because host 14 must keep a copy of all non-acknowledged packets so they can be retransmitted if lost.

This leaves the denominator of the right side of Eq. 4. The processing time of first host 12 and the networking delays Tn can be thought of as constants. Thus, the other delay from which efficiency gains may realistically be realized is the delay represented by variable Trgc 24 in Eq. 4. There are a variety of methods known in the art for decreasing Trgc 24. For purposes of discussion, it is assumed that these methods have already been applied and that Trgc 24 cannot be optimized any further. Therefore, there is a need in the art for another method that can reduce the delay amount Trge 24.

### SUMMARY

The point in time at which Trge 24 begins in relation to the reception of a data packet at access terminal 28 is changed. When a data packet is received at access terminal 28 from first host 12, a request for bandwidth is sent from the access terminal to scheduler 26 for one or more acknowledgement packets. This provides the advantage that the packet rate is increased even though Trgc 20 has not been changed.

### BRIEF DESCRIPTION OF DRAWINGS

FIG. 1 illustrates a sequence diagram showing the sending and receiving of message packets according to a connection oriented protocol.

FIG. 2 illustrates a sequence diagram showing anticipating sending of a bandwidth request message before a data packet acknowledgement packet is received.

FIG. 3 illustrates anticipated requesting of bandwidth and acknowledgement aggregation.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

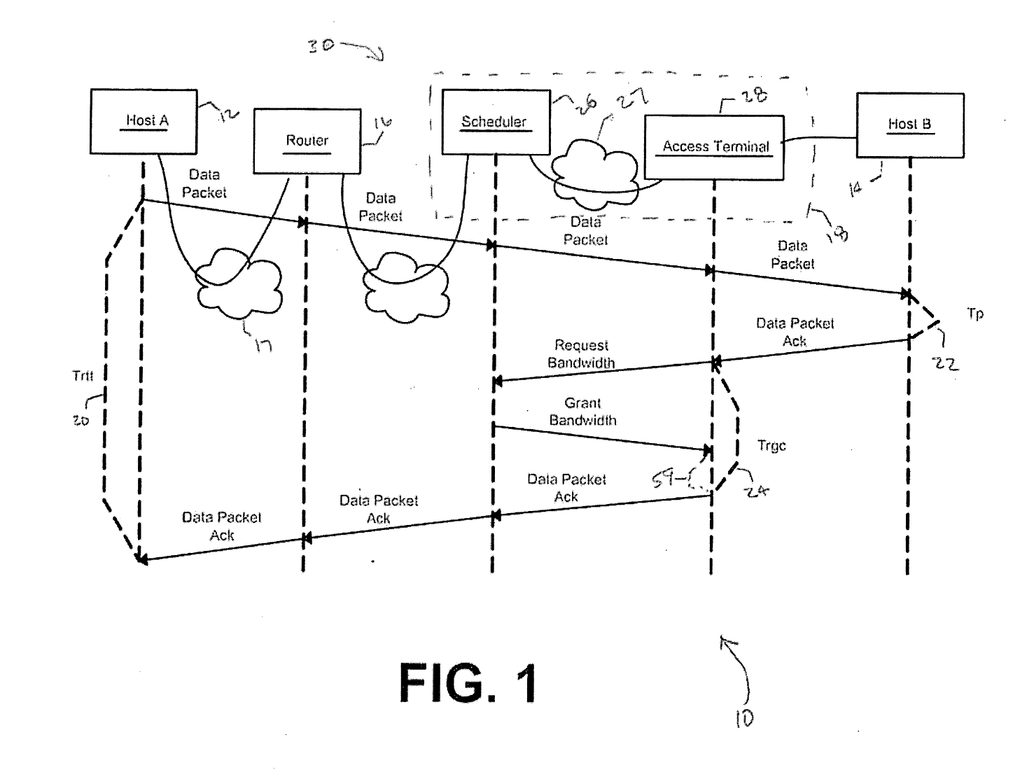

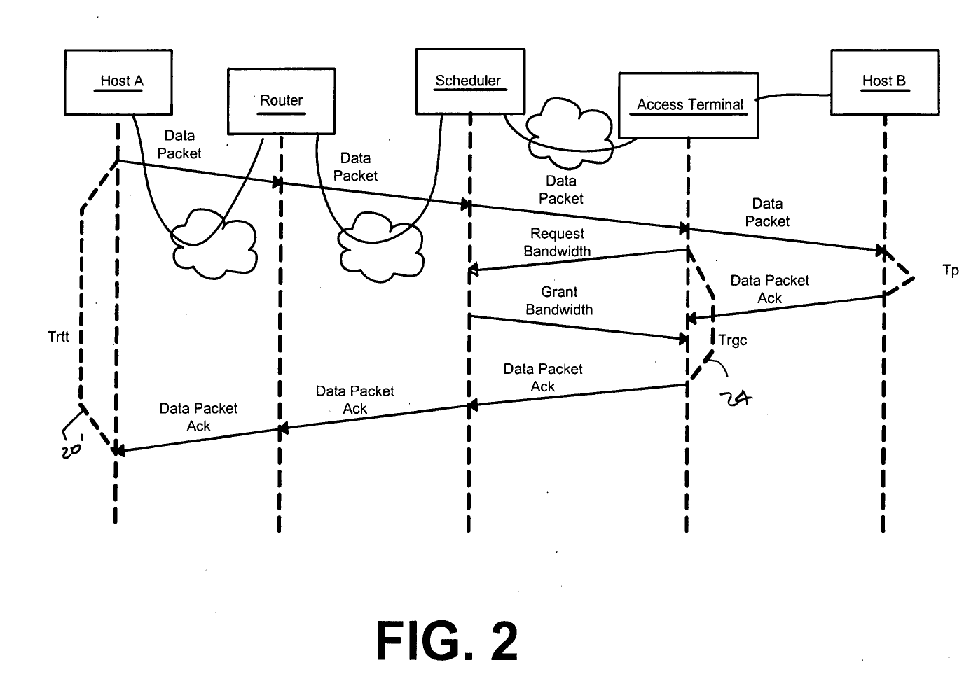

Turning now to FIG. 2, sequence diagram shows the sending of a bandwidth request message before a data packet acknowledgement packet is received. It is noted that Trgc 24 has not changed with respect to FIG. 1, but that Trtt 20′ is shorter than in FIG. 1. When a data packet is received at access terminal 28, a request for bandwidth is sent back to scheduler 26 before an acknowledgement packet from second host 14 is received indicating that the data packet was received by the second host. The bandwidth request may request bandwidth large enough to accommodate K acknowledgements, where K is a configurable parameter. Thus, multiple data packets may be received and only one request for bandwidth to transmit the corresponding multiple acknowledgements is needed. This supports a process known in the art as aggregation, where access terminal 28 receives more than one acknowledgement from second host 14 before it makes a bandwidth request.

It will be appreciated that aggregation is the process of receiving more than one acknowledgement at an access terminal from a host before generating a bandwidth request. The access terminal uses knowledge of the protocol—usually TCP—and discards the earlier acknowledgement(s) in favor of the last-received acknowledgement.

A pseudocode instruction for performing the operation may be as follows:

If (a data packet is received from the direction of the centralized scheduler)
(Send a request for bandwidth that is large enough to accommodate K acknowledgements)

End If.

It will be appreciated that pseudocodem, according to California Polytechnic State University, “is a kind of structured English for describing algorithms. It allows the designer to focus on the logic of the algorithm without being distracted by details of language syntax.” http://www.csc.calpoly.edu/˜jdalbey/SWE/pdl_std.html.

Another pseudocode variation may be:

If (a data packet from a connection oriented protocol is received from the direction of the centralized scheduler)
(Send a request for bandwidth that is large enough to accommodate K acknowledgements)

End If.

Yet another variation may be:

If (a TCP data packet is received from the direction of the centralized scheduler)
(Send a request for bandwidth that is large enough to accommodate K acknowledgements)

End If.

In each of these embodiments, K is a configurable value. If K=1, only anticipation is implemented because the bandwidth request is sent upon receipt of a data packet from the centralized scheduler rather than waiting for a data packet acknowledgement to be received from the destination host. Similarly, if K>1, anticipation and aggregation are implemented.

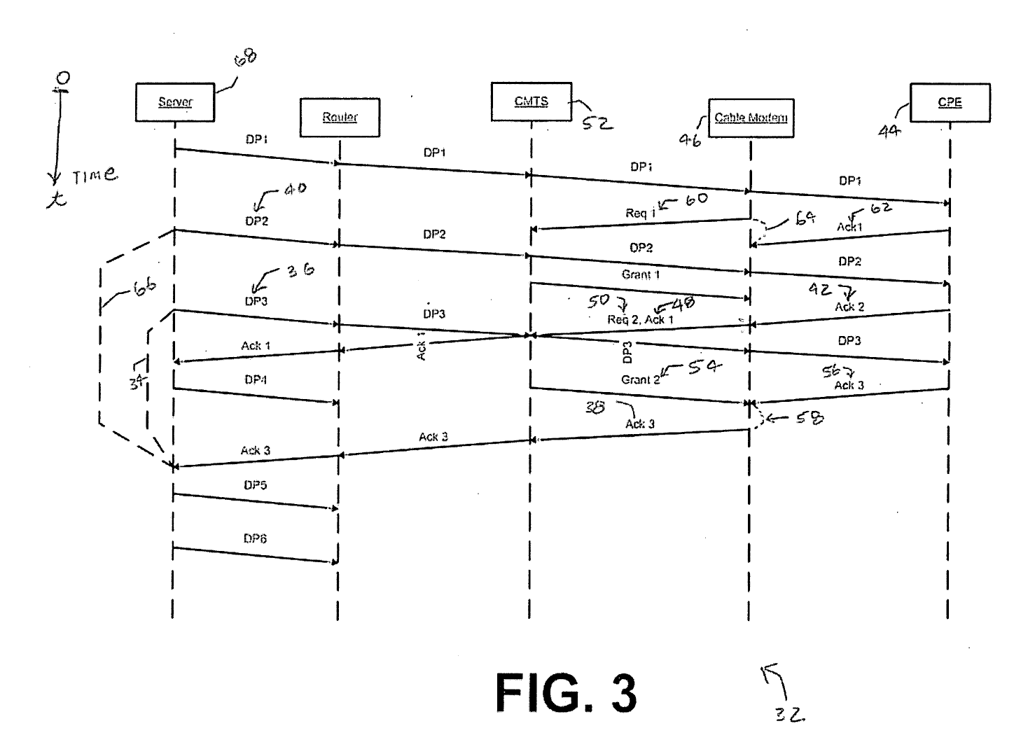

In FIG. 3, a sequence diagram 32 shows the use of anticipated requesting of bandwidth combined with acknowledgement aggregation to reduce the round trip time 34 of a data packet 36 being sent to a corresponding acknowledgement packet 38 being received. In the example shown, aggregation is used to generate acknowledgement packets that perform the acknowledgement function for both data packets DP2 40 and DP3 36. In addition, the receiving of an acknowledgement packet ACK2 42 from host CPE 44 is anticipated by cable modem 46. Diagram 32 shows that acknowledgement packet 48 for DP1 and the request packet REQ2 50 are sent to CMTS concurrently. In the figure, the receiving of grant 2 54 from CMTS 52 and the receiving of ACK 3 coincide at cable modem 46. After processing time 58 at cable modem 46, ACK 3 38 is sent, acknowledging that DP2 40 and DP3 36 have been received at host CPE 44.

It will be appreciated that the vertical spacing in the time domain in diagram 32 may not be to scale, but is given to show the relationship between the occurrence of various steps in the process of performing connection oriented protocol transmission of packets. Thus, even though the time 58 that elapses between the receiving of Grant 2 54 and the sending of ACK 3 38 may not appear to be less in the figure than the corresponding time 59 in FIG. 1, it will be appreciated that time 58 in FIG. 3 is less than it would be if REQ1 60 did not anticipate the receiving of ACK 62 by the amount 64. This is because the request REQ2 50 for bandwidth to send acknowledgements for reception of DP2 40 and DP3 36 occurs at the same time as the sending of ACK1 48. Since the sending of REQ1 60 anticipated the receiving of ACK1 62, REQ2 50 and the corresponding grant GRANT2 54 occurred sooner by the same amount than if the sending of REQ1 60 had not anticipated the receiving of ACL1 62. In the figure, the round trip time 66 between the sending of DP2 40 and the receiving of ACK 3 38 at host server 68 appears to be long relative to time 34 because ACK 3 has been aggregated to function as the acknowledgement for DP 2 and DP 3 36. However, the average of times 66 and 38 is less than if cable modem 60 did not anticipate the receiving of ACK 1 62 by sending bandwidth request REQ 1 60 earlier than ACK 1 62 is received by time 64. Moreover, round trip time 66 is shorter than if the sending of REQ1 60 had not anticipated the receiving of ACL1 62. Thus, anticipation can interoperate with conventional aggregation methods to further increase packet rate, although actual bandwidth may stay the same.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A method for increasing the packet processing rate between a plurality of hosts in a communication network, comprising:
receiving at an access terminal a data packet from a scheduler;
forwarding the data packet to a second host that is associated with the access terminal;
sending a data packet acknowledgement packet from the second host to the access terminal acknowledging that the data packet was received by the host;
anticipating at the access terminal the sending of the data packet acknowledgement packet; and
sending a bandwidth request packet from the access terminal to the scheduler requesting bandwidth to send the data packet acknowledgement packet from the second host to a first host before the data packet acknowledgement packet is received at the access terminal from the first host.

2. The method of claim A wherein the first host is a server.

3. The method of claim 2 wherein the server is a video server.

4. The method of claim 1 wherein the second host is a customer premise equipment device.

5. The method of claim 4 wherein the customer premise equipment device is a cable modem.

6. The method of claim 4 wherein the customer premise equipment device is a media terminal adaptor.

7. A method for increasing the packet processing rate between a plurality of hosts in a communication network, comprising:
receiving at an access terminal a data packet from a scheduler, the data packet being destined for a host; and
sending a bandwidth request message from the access terminal to the scheduler requesting bandwidth to send one or more data packet acknowledgement messages generated by the host before the one or more data packet acknowledgement messages is/are received at the access terminal from the host.

8. The method of claim 7 wherein the data packet originated at a first host that is a server.

9. The method of claim 8 wherein the server is a video server.

10. The method of claim 7 wherein the host to which the data packet is destined is a customer premise equipment device.

11. The method of claim 10 wherein the customer premise equipment device is a cable modem.

12. The method of claim 10 wherein the customer premise equipment device is a media terminal adaptor.

13. The method of claim 7 wherein a data packet acknowledgement message is sent after a predetermined number of data packets have been received from the scheduler.

14. The method of claim 13 wherein the data packet acknowledgement message serves as acknowledgement for the previously received predetermined number of data packets.

15. The method of claim 7 wherein a connection oriented protocol is used to transmit packets in the communication network.

16. The method of claim 15 wherein the connection oriented protocol is TCP.
